(19) United States
(12) Patent Application Publication
(10) Pub. No.: US 2003/0028849 A1
(43) Pub. Date: Feb. 6, 2003

(54) Display of a document on a client computer

(76) Inventors: Maarten Peter Bodlaender, Eindhoven (NL); Nicolaas Willem Schellingerhout, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 10/208,673

(22) Filed: Jul. 30, 2002

(30) Foreign Application Priority Data
Aug. 3, 2001 (EP) 01202947.6

(51) Int. Cl. G06F 15/00

(52) U.S. Cl. 715/513

(57) ABSTRACT

A method of displaying a document e.g. an XML document on a client computer the document comprising data as elements enclosed by tags. The method comprises the steps of retrieving a document from a document server, searching the document for code attribute information, retrieving program code from a code server and displaying the data in the retrieved document by means of the retrieved program code. The method further comprises the steps of retrieving program code from the client computer if the program code is present on the client computer, displaying data of the retrieved document in a default way if the program code could not be retrieved, and deciding whether the retrieved program code should be a plug-in to the method of displaying a document on a client computer. A system for displaying a document on a client computer with a document server with documents and a code server with program code.

This invention relates to the displaying of a document on a client computer, the document comprising data as elements enclosed by tags.

Moreover, the invention relates to a system and a computer program product for the display of a document on a client computer.

Finally, the invention relates to a document comprising data as elements enclosed by tags.

On-line services are accessible on the World Wide Web (WWW), which operates on the global Internet network. The World Wide Web provides a “web” of interconnected document objects. On the WWW these documents are located at various sites on the global Internet and can generally be accessed by a client computer that is connected to the Internet. Among the types of objects accessed via an on-line service are documents and scripts. Documents that are published on the WWW can e.g. be written in (hyper) Text Mark-up Languages such as HTML and XML.

Mark-up refers to the sequence of characters or other symbols that can be inserted at certain places in a text or word processing file to indicate how the file should look when it is printed or displayed or to describe the document's logical structure. The mark-up indicators are often called “tags”.

On the one hand an HTML document includes a merged combination of data and mark-up elements; most elements have a start tag followed by content, followed by an end tag. The content is a combination of text and nested mark-up elements. Tags, which are enclosed in angle brackets (‘<’ and ‘>’), indicate how the document is structured and how to display the document, as well as destinations and label for hypertext links. There are tags for mark-up elements such as titles and headers, text attributes such as bold, italics, font size etc, lists, paragraph boundaries, links to other documents or other parts of the same document, embedded graphical images in known file formats as an example JPG and many other features.

On the other hand an XML document mainly contains data in a tag-marked structural way. Typically an XML document is linked to a XSL document that mainly contains information on how to visualize the data in the XML document.

In other words the mark-up language is a way to express and to identify structures and presentation for a document written in the mark-up language.

To view an HTML or XML document a viewer to display is used. The viewer could be a Web browser that can be compatible with one or several Mark-up Languages and can, in lack of knowledge of certain parts of an XML or HTML document, perform a default display of these parts. HTML originally defined the standards for documents on the web. HTML only describes visual mark-up, where XML describes structural mark-up and has methods in the form of style-sheets to either add visualisation mark-up to a document or to translate a document to a visual mark-up language such as HTML. Around 1998 XML was created as a different type of language as opposed to HTML, but still an HTML capable Web browser will be able to appropriately display most elements of a document written in XML.

Three browsers are well known, the two most popular browsers for a personal computer environment being the competing browsers from Netscape and Microsoft. A third less known browser is the Opera browser. Opera, which is available for BeOS, EPOC, Linux, Mac, OS/2 and Windows operating systems, is being used as the browser of choice for hand-held Internet devices as it is a compact browser.

Generally, when browsers are to be extended in their functionality so-called plug-ins are added to the browser, these plug-ins may be free-of-charge demo versions of commercially available products freely downloadable from the Internet e.g. RealAudio, RealVideo, Shockwave. By means of such plug-ins additional functionality can be added to the browser to display image, to show vector graphics, to play sound or to create other visual effects when data is to be displayed on the screen. When a lack of functionally is detected in the browsing of a certain web page—the user may be asked whether such a plug-in should be installed on the browser.

The language of expressing an XML document is extensible the extensions of XML could be new types of documents, elements and attributes.

However, an XML browser cannot display XML tags other than by using a generally known standard tree view. As an example specialized display methods for XML defined languages such as scalable vector graphics suffer from the extensibility of XML, when scalable vector graphics are extended. Old displays method for scalable vector graphics will not be able to display newly defined elements and attributes.

WO 00/58817 discloses a method and a system for providing a device, primarily a digital camera but also PCs, palmtops etc. with a display with a Web based graphical user interface. The graphical user interface can be updated via downloads from the Web. The system has a meta-language application, which defines the graphical user interface. The meta-language application is comprised of one or more XML files, DTD document type definitions, Java script files, cascading style sheets and behaviour scriplet files. The meta-language application controls the graphical user interface. A meta-language parser interprets and displays the graphical user interface when the camera is powered up.

Thus, WO 00/58817 discloses a method where a meta-language parser visualizes data by use of known XML language and scripts.

The prior art method involves the problem that when a document is displayed only the standard functionality of the browser displaying it can be used.

This problem is solved when the method of displaying a document on a client computer comprises the steps of:

retrieving a document from a document server;

searching the document for code attribute information;

retrieving program code from a code server in response to the code attribute information;

displaying data in the retrieved document by means of the retrieved program code.

Hereby a searched code attribute of a retrieved document from a document server in the form of retrieved program code from a code server determines how the document is displayed.

How data is displayed, referred to in the code attribute may thereby generally be changed. This means that the display of data is no longer tightly bound to the XML page in that the program code of the Web sites on a code server may be changed reflecting a new way of displaying data even though the wording of the code attribute in XML page is left unchanged.

However, the wording of the code attribute itself in the XML document may be changed, too, thereby achieving another display of the data in that another Web site on the code server refers to another program code.

It is therefore an advantage of the invention that the invention offers at least two possibilities for change of a display of data: in the program code on a code server referred to in the code attribute and or in the wording of the code attribute itself in the XML document

The problem is further solved when the method of displaying a document on a client computer further comprises the steps of:

retrieving program code from the client computer if the program code is present on the client computer; thereby, the method of the invention will first try to retrieve program code on a client computer before an attempt is made to retrieve program code from the code server and thereby a need to retrieve the program code via a time consuming access to the Internet may be avoided;

deciding to ignore the code attribute in response to the plug-ins; plug-ins to the method of displaying a document may decide to ignore the code attribute, when it is appropriate in the display of data;

displaying data of the retrieved document in a default way if program code could not be retrieved; thereby, the method of the invention can display data even though program code could not be retrieved; and

deciding whether retrieved program code should be a plug-in to the method of displaying a document on the client computer.

The display of data referred to in the code attribute may thereby be changed in that the XML browser may retrieve plug-ins in the form of a program code, thereby allowing an element and its content to be displayed in another way even though the contents of the XML document are not changed. The plug-in may not be plugged in if it cannot be run on the client computer.

The prior art method further involves the problem that—when a document is displayed—only the calls of the standard display functions of the browser referred to in the document can be used.

This problem is solved when the document comprises a code attribute that refers to program code on a code server where program code can display the data.

This means that the display of a document may be changed in that a changed wording of the code attribute in the document may let the browser retrieve another program code on another code server whereby this program code determines another display of the data of the document.

The invention will be explained more fully below in connection with preferred embodiments and with reference to the drawings, in which:

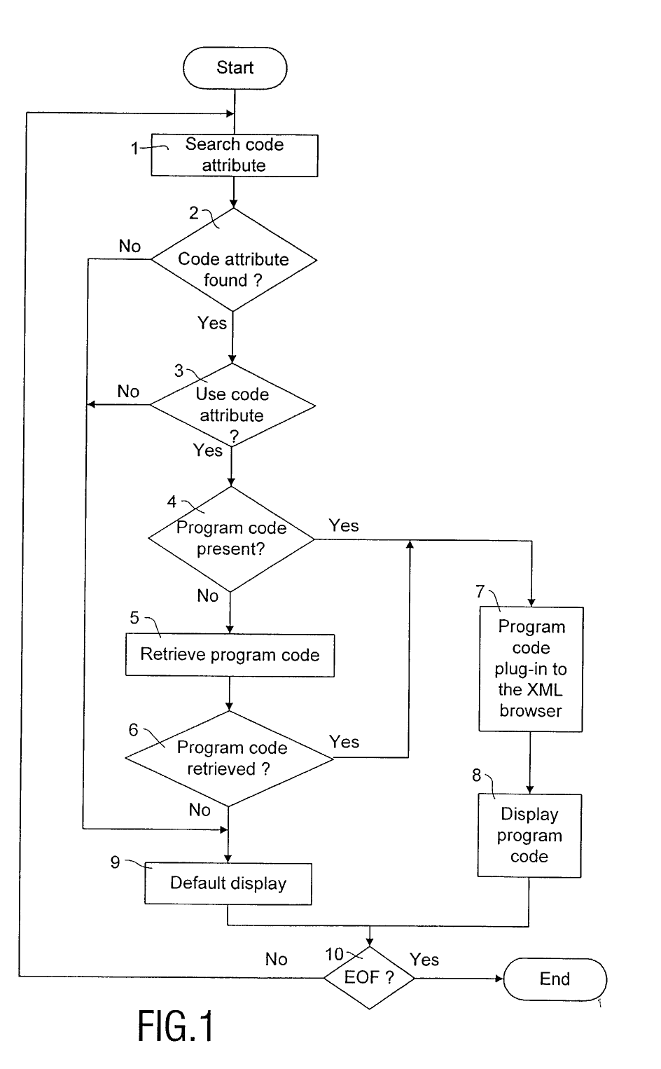

FIG. 1 shows a method by which the XML browser displays an XML document; and

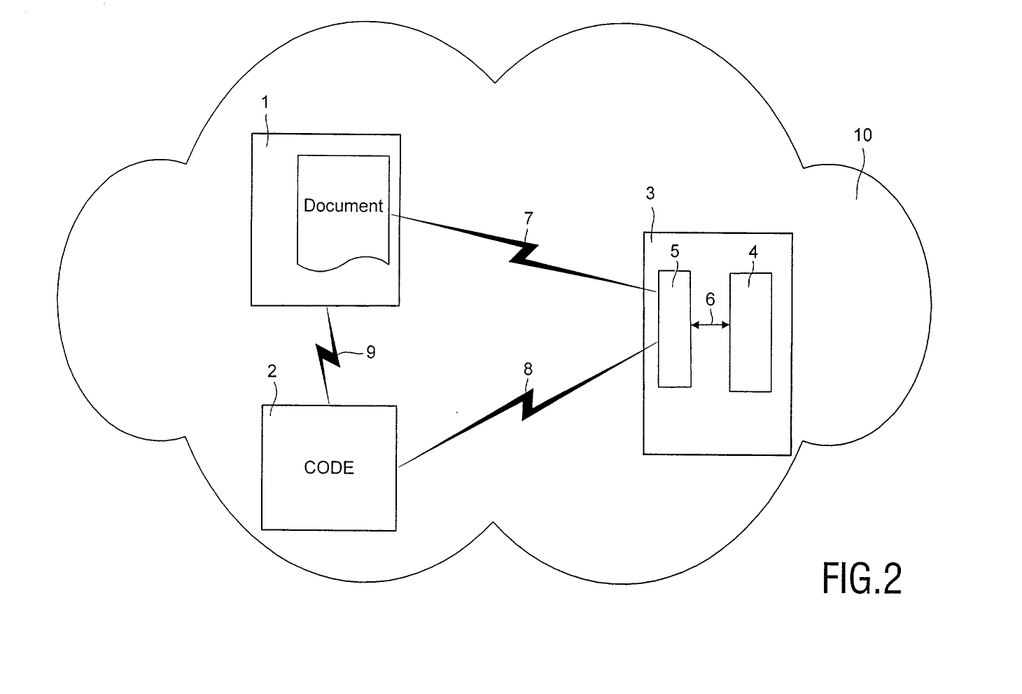

FIG. 2 shows a client server's configuration of the invention.

FIG. 1 shows a method by which the XML browser displays an XML document. At start—before the entering of step 1—the XML document or part of it is loaded on the client computer. The XML document is retrieved from a document server, when the user sitting at the client computer is browsing or surfing on the Internet. The connection between the client computer and the document server and a code server is described in FIG. 2. The characters of the document or the XML document are read into the memory of the client computer and from there searched, interpreted and displayed, as shown in more details in the following. The document is read from the memory and a Boolean variable e.g. a flag is initialised to a reset status (e.g. CODE found=false). The document is now searched for code attribute information. If the characters of the XML document contain a sequence of CODE including ‘=’” after the CODE is found, an XML code attribute is found. The boolean variable e.g. a flag is set (CODE-found=true) to indicate that an XML code attribute was found and the content of the XML code attribute is saved in a string variable e.g. “codecontent” for later examination. Hereafter the method proceeds in step 2.

In step 2, the flag CODE-found is examined, if this is true the method proceeds to step 3, where an interpretation of code attribute and an attempt to execute program code referred from “codecontent” may be performed. If CODE-found was examined to be false the method proceeds in step 9.

In step 3 the code attribute is examined further. The plug-ins of the browser may—at this point—decide to ignore the code attribute even though the program code for it has been retrieved. It may be appropriate not to use the code attribute in the display of data. If data was actually displayed using the code attribute—unwanted effects like overlapping data, conflicting sounds, overlapping windows may be the result. The program code of the code attribute may conflict with the hardware configuration (the display, the functionality of the display or the video card, the memory of the video card, CPU type and speed, etc.) of the client computer shown in FIG. 2, and it may therefore be appropriate to ignore the code attribute. Hereafter, the method proceeds in step 4.

In step 4, it is checked whether the program code referred to from “codecontent” is in the workspace, e.g. in the cache memory of the client computer, as the program code of the “codecontent” may have been used previously by the current application or by another XML browser retrieving it e.g. the XML browser may have been started several times. It may further be checked whether the program code referred to in the “codecontent” has already been plugged in to the display functionality of the XML browser and thereby the program code can here be made ready to use in the workspace of the client computer. If the program code is already in the workspace e.g. in the cache of the client computer—there is no need to retrieve it again—the method proceeds in step 7. If the program code is not in the workspace the method proceeds in step 5.

In step 5, on the basis of the “codecontent” a corresponding code server, or an internal client file is addressed to retrieve the program code (it may be an object with classes or and subclasses) for the display of the element or elements in the currently opened XML browsed page or document. For a more detailed explanation, a code server, a client computer and a document server system are shown in FIG. 2. After retrieval, the program code is made resident in the workspace of the XML browser to be used when an element or the following elements in the next following lines of the current opened XML browsed page have to be displayed using the same code attribute. The information in the string “codecontent” may, as examples of preferred embodiments of the invention, be derived from one or two of the following lines of an opened XML browsed page or document:

<citymap CODE=“http://maps.com/Contours.class”>

<title CODE=“http://maps.com/Fading.class”>Eindhoven

area</title>

where the text after CODE=” refers to Web sites placed on code servers on the Internet in that the program code referred to in the “codecontent” may be retrieved by use of the http protocol. Further, after the http string—as known from referring web sites on the Internet—is ended, additional parameters or variables may be included in the string “codecontent”.

An internal file on the client computer or an external file may be referred to in another preferred embodiment of the invention e.g. when the text after CODE=” contains: file:/ . . . etc”, etc, equals the drive (internal, external, network drive) filename and file-extension as known from hyperlinks in and to documents and files.

Generally, any Web site on the code server, internal file on the client computer or external file may be addressed to retrieve the program code for the display, and thereby any display of an object, element etc. can be performed. This means that the visualisation is no more bound to the XML document or the document in that the content and or the name of the Web sites of a code server, the internal file on a client computer or the external files referred to in the code attribute may be changed.

After processing of step 5 the method proceeds to step 6.

In step 6, a Boolean variable may hold information whether the program code of the code server, the external file server or the internal client file on the client computer could be retrieved, and thereby the program code of the “codecontent” was stored in the workspace of the client computer. In a preferred embodiment of the invention it will in the first place be searched when it is to be determined whether the program code could be retrieved from the client computer, and in the second place an attempt to retrieve the program code from the code server is performed. If this is not the case the method proceeds in step 9 because program code could not be retrieved, otherwise the method proceeds in step 7.

In step 9, data of the retrieved document is displayed in a default way. The request to retrieve program code was not successful or it was previously decided by one or more of the plug-ins of the browser to ignore the code attribute, therefore a default display of the element or elements is performed, e.g. a sophisticated blinking visualisation of a text element may have been attempted, but—as the request to retrieve the sophisticated blinking visualising program code was not successful or it was decided to ignore the code attribute—the visualisation of a text element will be shown in a default standard way non blinking or in some less sophisticated default standard blinking manner of a standard XML browser. The method will interpret part or parts of the document currently being interpreted as usual XML code, e.g. tags within tags are ordinarily handled, java applet and scripts are handled as usual; if—as an example—the method is interpreting a structured element comprising several lines of text, the lines are handled in the expected context-sensitive way as known from prior art XML browsers etc. Generally speaking, in a preferred embodiment of the invention there is a fall back to a default display way like the standard three view of XML thereby ensuring code compatibility with older XML browsers. Hereafter the method returns to step 1 for a continued search for a code attribute and for the display of the remaining document or XML document if the end of file of proceeding to the next step 10 was not reached.

In step 7, it is decided whether retrieved program code should be a plug-in to the method of displaying a document or a plug-in to the XML browser on the client computer. It may be the case that the client computer on several occasions lacked a special display program code; therefore it may be appropriate in a preferred embodiment of the invention in this step to add the special display program code as a plug-in to the display functionality of the XML browser. This means that the XML browser—when plug-ins have been added to it—is an XML browser extended with more functionality. A possible plug-in may not be plugged in to the method of displaying a document if it cannot be run properly on the client computer. A plug-in may conflict with the hardware configuration (the functionality of the display or the video card, the memory of the video card, the speed and type of CPU etc.) of the client computer, and thereby it may be appropriate not to plug it in. Generally, when the term XML browser is used, it may be understood as the XML browser with its plug-ins. After the decision whether a retrieved program code should be a plug-in to the XML browser, the method proceeds to step 8.

In step 8, the request to retrieve program code was successful or the program code was already present on the client computer, thereby the display in a preferred embodiment of the invention of an element or elements in a document may be done, e.g. a rotating visualisation of a text element may be performed. The resident program code which was stored in the workspace of the XML browser or the newly added plug-in of the browser is here run or executed when the element or the following elements in the next following lines of the current opened XML browsed page are displayed. As the XML browser considers from one line to more lines as a batch, the display of the element or elements is executed when all the necessary elements, visualisation code or classes in form of program code etc. are present in the workspace of the client computer. Hereafter the method proceeds to step 10.

In step 10, either a default display or a display in a preferred embodiment of the invention was executed as a result of the program code referred to in the code attribute. If the XML document or document has not been displayed completely—the end of file of the document in step 10 was not reached—the method returns to step one for a continued display of the XML document or document. Otherwise the method proceeds to an end.

As long as the document has not been examined and displayed to the end, the method will loop back to step 1. In other words the steps are repeated until all the lines of the XML document have been read and or the end of file of the XML document has been reached. If—when searching through the lines—line or lines of non XML code are found e.g. a java applet etc.—these lines are interpreted as known from prior art XML browsers with the corresponding interpretation and execution belonging to these lines.

The XML browser referred to in the above-mentioned description may generally be understood as an XML browser with its plug-ins and may also be understood as a method of displaying a document.

The XML code attribute may generally be understood as a code attribute in a document determining how data in the document should be displayed.

FIG. 2 shows a client server's configuration of the invention. In this figure a minimum client and server's configuration of the invention in a preferred embodiment is shown. Reference numeral 1 refers to a document server and reference numeral 2 refers to a code server. Reference numeral 3 refers to a client computer, which may be any type of a client computer, it may be a laptop, a PC or any other electronic device that can access and connect to the Internet.

Reference numerals 7, 8 and 9 refer to Internet connections within the Internet 10 between the client and the servers of the system.

The document server has the document or XML document which may be requested and retrieved by the client computer. The code server may hold the previous mentioned “codecontent” in the form of program code referred to in the code attribute.

When the user is browsing the Internet or is trying to display a document at the client computer, the document may have a link or a reference to a document or an XML document on a document server. The document or the XML document may be the one retrieved through the Internet to be displayed on the client computer by means of the display software 4 residing on the client computer. If the display software detects a code attribute in the document—as previously explained in FIG. 1—, the client will make a request by means of an Internet interface 5 of the client to the code server for the “codecontent” in the form of program code referred to in the code attribute. If the code server has the program code, it will be retrieved by the client computer from the code server and the program code will then be transferred through the interface 6 between the Internet interface 5 of the client computer and the display software 4 to the display software to be executed on the client computer. If the code server could not deliver the program code, the client will ignore it and—as also explained in FIG. 1—perform a default display of the code attribute instead.

The document server may deliver a program code to the code server when the administrator or the webmaster at the document server can foresee a demand in the future for program code as an updated document on 1 may contain a new code attribute where the actual program code referred to is not present on 2.

The document server may generally be provider of web-pages, websites in the form of documents etc.

As examples of a preferred embodiment of the invention a code server may have a special program code for the code attributes for a music player and or program code referred to in the code attributes for a combined playing of movies and stereo sound or for any other presentation and display purpose of data.

The code server may thereby generally be a provider of program code for displaying and presenting data e.g. data in the form of text, sound, music, movies, 3D and combinations thereof.

More document servers and code servers may be used than shown in FIG. 3 in that a document and a code attribute may refer to web sites, to links and or to files that may reside on any other than the two servers shown. Further a web site and or a file referred to may be moved and then reside on any other server, thereby the client server's configuration of the invention is dynamically upgradeable in the number and the use of the servers.

Finally, one preferred embodiment of the invention of an XML document is shown:

1 <citymap CODE=“http://maps.com/Contours.class”>

2 <title CODE=“http://maps.com/Fading.class”>Eindhoven area</title>

3 <street><name>Prof. Holstlaan</name>

4 <XY>123,345</XY>

5 <XY>234,467</XY>

6 </street>

7 <street> . . . </street>

8 . . .

9 </citymap>

Reference numerals of the XML document are briefly commented in the following.

1) The displaying method described in FIG. 1 is started.

2) ‘Contours.class’ is detected and run on the <citymap> sub-structure, displaying it in a proprietary way.

3) ‘Contours.class’ asks the method of displaying to display <title>. The method displaying detects ‘Fading.class’ and runs that on the <title> substructure.

4) The <street> and <name> substructures are displayed in a default way. This default may be the browser's built-in default visualisation method, OR ‘Contour.class's’ built-in visualisation method for displaying <street> and <name>.

5) A street segment (denoted by the <XY> substructure) is displayed in a default way.

6) A street segment (denoted by the <XY> substructure) is displayed in a default way.

7) The <street> substructure has been displayed.

8) Indicates that more lines of code may be added here.

9) The <citymap> substructure has now been displayed.

Here, if the program code for displaying cannot be retrieved from the code server, the document with the code attribute can still be displayed in a default way by existing browsers that generally understand XML documents.

A computer readable medium may be magnetic tape, optical disc, digital video disk (DVD), compact disc (CD or CD-ROM), mini-disc, hard disk, floppy disk, smart card, PCMCIA card etc.

1. A method of displaying a document on a client computer, the document comprising data as elements enclosed by tags; the method comprising the steps of:
retrieving a document from a document server;
searching the document for code attribute information;
retrieving program code from a code server in response to the code attribute information;
displaying data in the retrieved document by means of the retrieved program code.

2. A method of displaying a document on a client computer according to claim 1, characterized in that the method further comprises the steps of
retrieving program code from the client computer if the program code is present on the client computer;
deciding to ignore the code attribute in response to the plug-ins;
displaying data of the retrieved document in a default way if program code could not be retrieved; and
deciding whether retrieved program code should be a plug-in to the method of displaying a document on the client computer.

3. A method of displaying a document on a client computer according to claims 1 through 2, characterized in that the document is an XML document.

4. A method of displaying a document on a client computer according to claim 1 through 3, characterized in that the client computer, the code server and the document server are connected to the Internet.

5. A system of displaying a document on a client computer with means for implementing the method of the claims 1 through 4.

6. A computer program product comprising program code means stored on a computer readable medium for performing the method of the claims 1 through 4 when said computer program is run on a computer.

7. A document comprising data as elements enclosed by tags, characterized in that the code attribute refers to program code on a code server where program code can display the data.

8. A document comprising data as elements enclosed by tags according to claim 7, characterized in that the document is an XML document.
